(19) United States
(12) Patent Application Publication
(10) Pub. No.: US 2006/0289598 A1
(43) Pub. Date: Dec. 28, 2006

(54) Stapler provided with an article accommodating space

(76) Inventor: Ching-Tsung Tsai, Hemei Township (TW)

Correspondence Address: TROXELL LAW OFFICE PLLC, SUITE 1404, 5205 LEESBURG PIKE, FALLS CHURCH, VA, 22041, US

(21) Appl. No.: 11/158,054

(22) Filed: Jun. 22, 2005

(51) Int. Cl. B25C 5/06

(52) U.S. Cl. 227/134; 227/120

(57) ABSTRACT

A stapler provided with an article accommodating space includes an upper casing base, a lower casing base and a staple box. The lower casing base is formed with an article accommodating space covered thereon with a casing cover. The casing cover has its opposite ends respectively provided with a hooking member and an engage member to be clasped and engaged with the lower casing base and covered on the accommodating space. The casing cover is able to be opened or closed easily and impossible to fall off.

### BACKGROUND OF THE INVENTION

1. Field of the Invention

This invention relates to a stapler, particularly to one having a lower casing base provided with an article accommodating space covered thereon with a casing cover easy to be opened or closed and able to be prevented from falling off.

2. Description of the Prior Art

A conventional stapler usually has its lower casing base additionally provided with an accommodating space for depositing staples, paper clips and the like so as to elevate its additional value and the accommodating space has its outer side covered with a plate cover.

However, the plate cover of the conventional stapler is combined with the outer side of the accommodating space by pressing forcedly; therefore, the plate cover is not easy to be opened or covered closely on the accommodating space, inconvenient in use. In addition, after used for a period of time, the plate cover made of plastic may be worn out and easy to fall off.

### SUMMARY OF THE INVENTION

The objective of the invention is to offer a stapler provided with an article accommodating space, composed of an upper casing base, a staple box and a lower casing base. The staple box is interacted with the upper casing base to be pressed down on the lower casing base to release staples for use. The lower casing base has its rear end bored with an accommodating space having its front vertical wall bored with an insert slot in the center and its rear vertical wall bored with a fitting hole. A casing cover to be covered on the accommodating space has its front end provided with a projecting hooking member matching with the insert slot in the front vertical wall of the accommodating space. The hooking member of the casing cover has its inner side formed with a hooking notch to be clasped with the upper edge of the insert slot. The casing cover has its rear end extending outward obliquely and forming a slope having its inner edge provided with an engage member matching with the fitting hole in the rear vertical wall of the accommodating space. To combine the casing cover with the accommodating space, the casing cover is first held perpendicular to the lower casing base and has the front edge of its hooking member inserted into the insert slot in the front vertical wall of the accommodating space. Then, the casing cover is turned backward to have its engage member engaged with the fitting hole in the rear vertical wall of the accommodating space, thus firmly combining the casing cover on the accommodating space.

The stapler in the present invention has its lower casing base formed with an article accommodating space for depositing small-sized stationary and its casing cover provided with a hooking member and an engage member to enable the casing cover to be easily turned open or firmly covered on the accommodating space, convenient in use and able to prevent the casing cover from falling off.

### BRIEF DESCRIPTION OF DRAWINGS

This invention will be better understood by referring to the accompanying drawings, wherein;

FIG. 1 is an exploded perspective view of a stapler provided with an article accommodating space in the present invention:

FIG. 2 is a perspective view of the stapler provided with an article accommodating space in the present invention:

FIG. 3 is a cross-sectional view of the stapler provided with an article accommodating space in the present invention:

FIG. 4 is a cross-sectional view of a casing cover in the present invention:

FIG. 5 is a cross-sectional view of the stapler in the present invention, showing that the casing cover is to be covered on the accommodating space of a lower casing: and FIG. 6 is a cross-sectional view of the stapler in the present invention, showing that the casing cover is to be opened.

### DETAILED DESCRIPTION OF THE PREFERRED EMBODIMENT

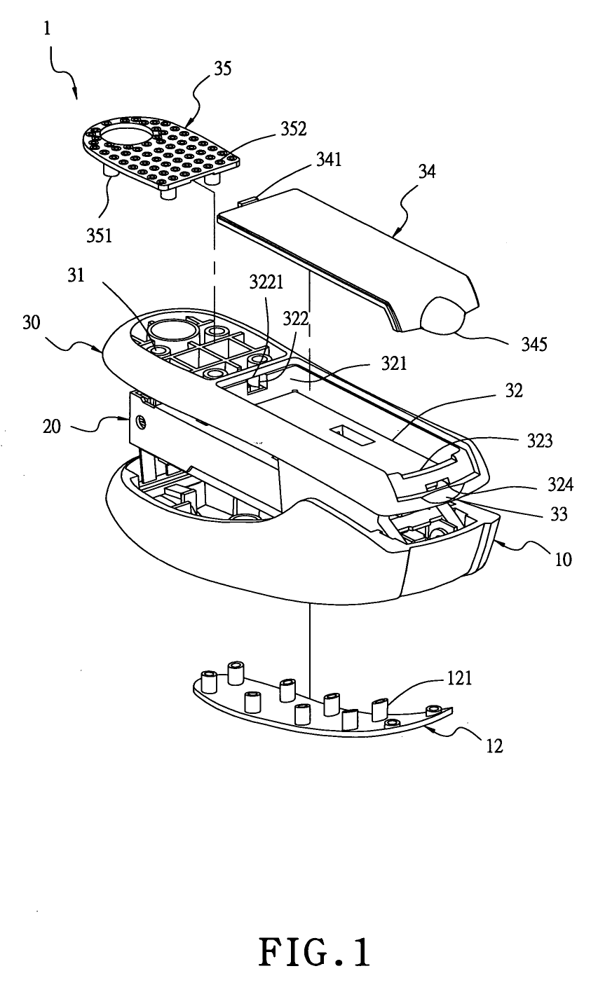

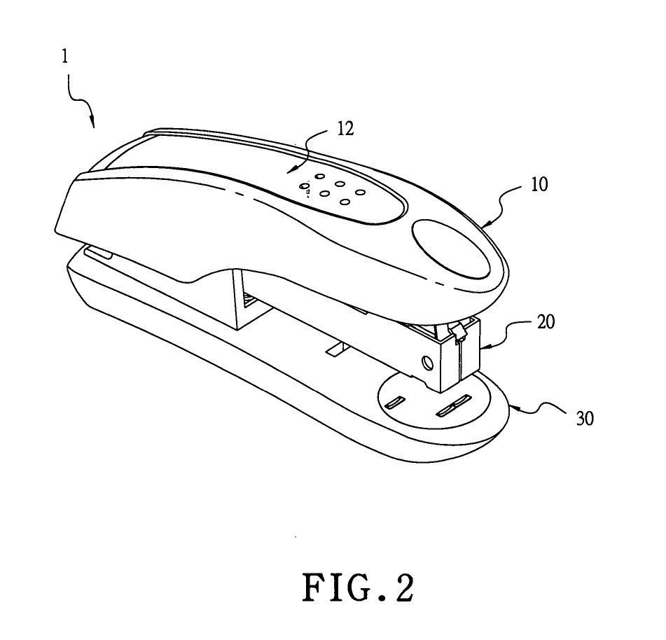

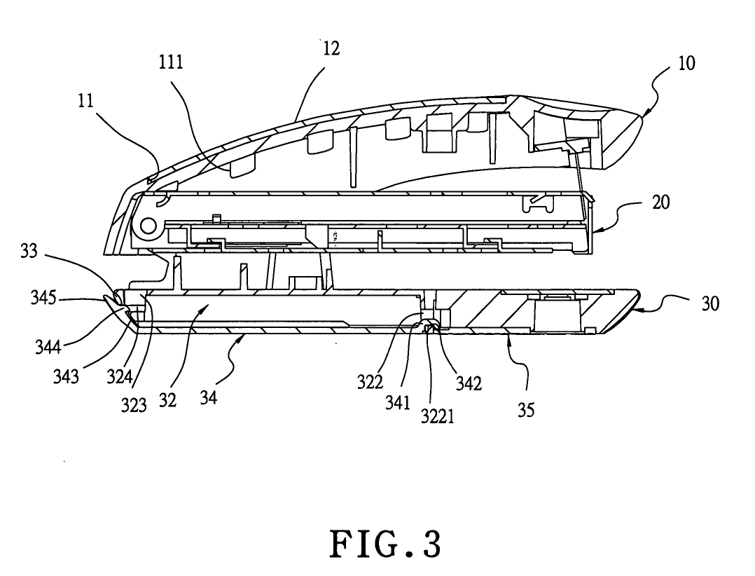

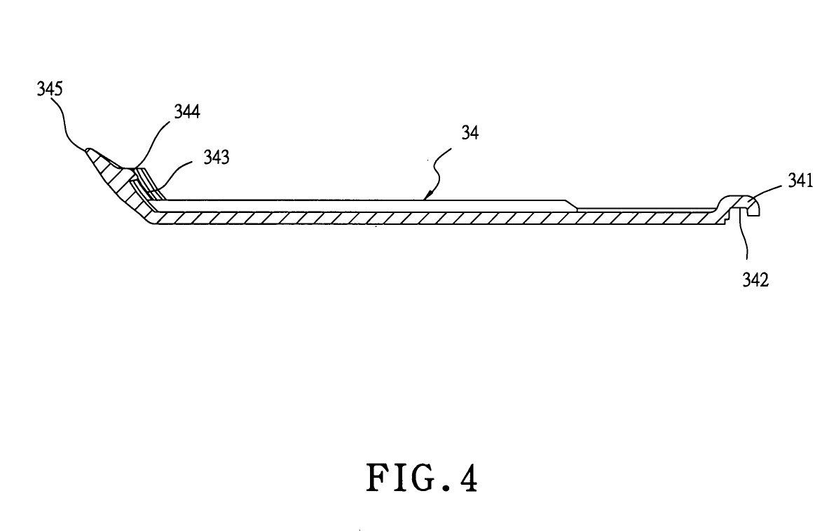

A preferred embodiment of a stapler provided with an article accommodating space in the present invention, as shown in FIGS. 1 to 4, includes an upper casing base 10, a staple box 20 and a lower casing base 30 combined together.

The upper casing base 10 made of plastic has its rear end formed with a recess 11 bored with plural insert notches 111. A plate cover 12 covered on the recess 11 is provided with plural insert pins 121 to be respectively inserted in the insert notches 111 of the upper casing base 10 for combining the plate cover 12 together with the upper casing base 10. The plate cover 12 can be altered in material and style for meeting a user's different requirements.

The stapler box 20 is interacted with the upper casing base 10 to be pressed down on the lower casing base 30 to release staples for use.

The lower casing base 30 made of plastic has its front end formed with plural recessed grooves 31 and its rear end bored with an accommodating space 32 for depositing articles therein. The accommodating space 32 has its front vertical wall 321 bored with an insert slot 322 in the center and its rear vertical wall 323 bored with a fitting hole 324 in the lower side. The lower casing base 30 has its rear side formed with an arc-shaped recessed surface 33.

In addition, a casing cover 34 to be covered on the accommodating space 32 has its front end formed with a projecting hooking member 341 matching with the insert slot 322 in the front vertical wall of the accommodating space 32 of the lower casing base 30. The hooking member 341 has its inner side formed with a hooking notch 342 to be clasped with the upper edge 3221 of the insert slot 322. The casing cover 34 further has its rear end extending outward obliquely and forming slope 343 having the inner edge fixed with an engage member 344 matching with the fitting hole 324 in the rear vertical wall 323 of the accommodating space 32, with a guiding slope formed at the outer end of the engage member 344. The slope 343 of the casing cover 34 has its outer end formed with a pull member 345 extending outward and corresponding to the arc-shaped recessed surface 33 of the lower casing base 30, which is provided with a preset space for facilitating the pull member 345 to be pulled for disengaging the engage member 344 from the lower casing base 30.

Additionally, a slide-resistant cover 35 to be covered on the recessed grooves 31 at the front end of the lower casing base 30 has its inner side provided with a plurality of insert pins 351 to be respectively engaged with the recessed grooves 31 for combining the slide-resistant cover 35 with the lower casing base 30 and its outer side fixed with numerous slide resistant rings 352 for increasing the frictional coefficient of the underside of the stapler 1 and stabilizing the stapler 1 when it is placed on the top of a table for use.

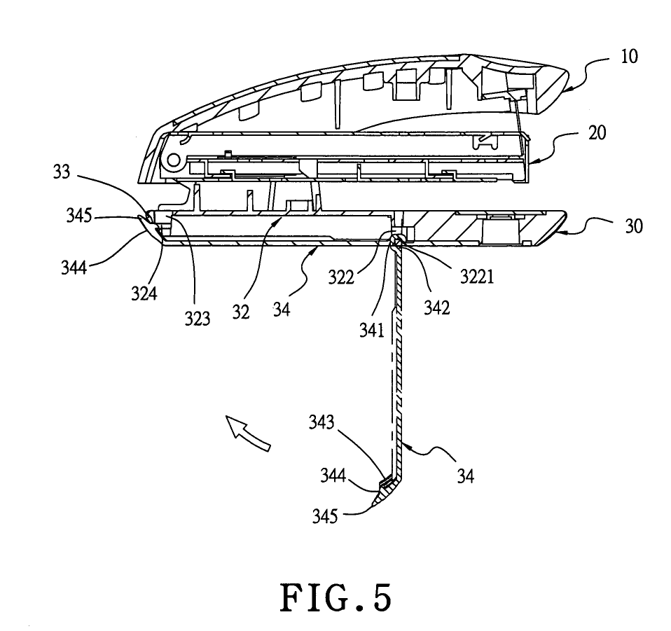

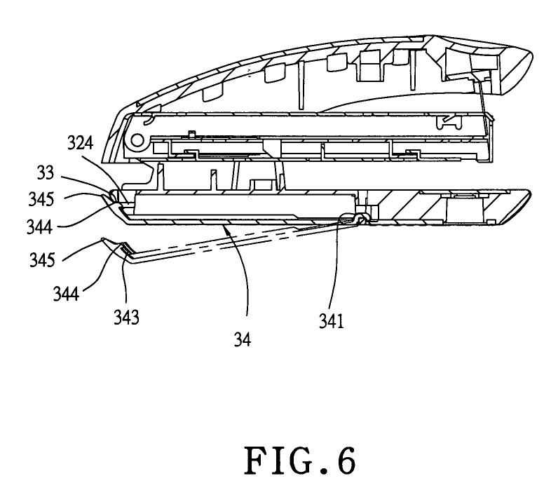

To combine the casing cover 34 with the accommodating space 32, as shown in FIGS. 5 and 6, firstly, the casing cover 34 is held perpendicular to the lower casing base 30 and has the front edge of its hooking member 341 inserted into the insert slot 322 in the front vertical wall 321 of the accommodating space 32 of the lower casing base 30 to let the hooking notch 342 of the hooking member 341 clasped with the upper edge 3221 of the insert slot 322 to prevent the casing cover 34 from falling off. To cover the casing cover 34 on the accommodating space 32, the casing cover 34 is turned backward and firmly combined with the accommodating space 32 by mutual engagement of the engage member 344 of the casing cover 34 and the fitting hole 324 in the rear vertical wall 323 of the accommodating space 32 of the lower casing base 30, able to prevent the casing cover 34 from disengaging from the accommodating space 32.

To open the casing cover 34 for putting articles in and taking them out of the accommodating space 32, only pull open the pull member 345 to disengage the engage member 344 of the casing cover 34 from the fitting hole 324 in the rear vertical wall of the accommodating space 32 of the lower casing base 30. After the casing cover 34 is turned open, the hooking member 341 of the casing cover 34 can be still clasped with the lower casing base 30.

As can be understood from the above description, this invention has the following advantages.

1. The casing cover and the accommodating space can be firmly combined together; therefore, after covered, the casing cover is impossible to disengage from the lower casing base, preventing the articles in the accommodating space from falling down and easy to turn open or close the casing cover. Additionally, after turned open, the casing cover has its hooking member still clasped with the lower casing base, preventing the casing cover from falling off.

2. The cover plate covered on the upper casing base 10 can be replaced with various plate covers of different styles or materials for matching with the styles a user prefers.

3. The slide resistant cover assembled on the front end of the lower casing base is able to increase frictional coefficient of the underside of the stapler and stabilize the stapler when it is placed on the top of a table for use.

While the preferred embodiment of the invention has been described above, it will be recognized and understood that various modifications may be made therein and the appended claims are intended to cover all such modifications that may fall within the spirit and scope of the invention.

I claim:

1. A stapler provided with an article accommodating space, said stapler comprising an upper casing base, a staple box and a lower casing base, said stapler box interacting with said upper casing base, said staple box together with said upper casing base pressed down on said lower casing base to release staples for use: and,
Characterized by said lower casing base having its rear end bored with an accommodating space, said accommodating space covered thereon with a casing cover, said accommodating space having its front vertical wall bored with an insert slot in the center, said accommodating space having its rear vertical wall bored with a fitting hole in a lower side, said casing cover having its front edge formed with a projecting hooking member matching with said insert slot in said front vertical wall of said accommodating space, said casing cover having its rear end extending outward obliquely and forming a slope, said slope of said casing cover having its inner side edge fixed with an engage member matching with said fitting hole in said rear vertical wall of said accommodating space, said casing cover first held perpendicular to said lower casing base and said hooking member of said casing cover inserted in said inset slot in said front vertical wall of said accommodating space and then said casing cover turned backward to be combined with said accommodating space, said casing cover able to be firmly assembled on said accommodating space by mutual engagement of said engage member of said casing cover and said fitting hole in said rear vertical wall of said accommodating space.

2. The stapler provided with an article accommodating space as claimed in claim 1, wherein said engage member of said casing cover has its outer end formed with a guiding slope.

3. The stapler provided with an article accommodating space as claimed in claim 1, wherein said guiding slope of said casing cover has its outer end extending outward and forming a pull member for facilitating pulling of said engage member, and said lower casing base has its rear end corresponding to said pull member of said casing cover formed with an arc-shaped recessed surface with a preset space for facilitating said pull member to be pulled

4. The stapler provided with an article accommodating space as claimed in claim 3, wherein said pull member is a guiding slope formed integral.

5. The stapler provided with an article accommodating space as claimed in claim 1, wherein said lower casing base has its front end bored with insert grooves preset in number and a slide-resistant cover is covered on said insert grooves of said lower casing base, said slide-resistant cover having one side fixed with insert pins preset in number, said insert pins inserted in said insert grooves to combine said slide-resistant cover together with said lower casing base, said slide-resistant cover having the other side provided with numerous slide-resistant rings.

6. The stapler provided with an article accommodating space as claimed in claim 1, wherein said upper casing base has its rear end formed with a recess bored with insert grooves preset in number and a plate cover is covered on said recess, said plate cover provided with insert pins preset in number, said insert pins respectively inserted in said insert grooves to combine said plate cover together with said upper casing base.
